(19) United States
(12) Patent Application Publication
(10) Pub. No.: US 2024/0312275 A1
(43) Pub. Date: Sep. 19, 2024

(54) KEY CONTAINER

(71) Applicant: KABUSHIKI KAISHA TOKAI RIKA DENKI SEISAKUSHO, Niwa-gun (JP)

(72) Inventors: Kenta TAKAGI, Niwa-gun (JP); Yuji NAKAMOTO, Niwa-gun (JP); Masashi TANOUE, Niwa-gun (JP)

(21) Appl. No.: 18/433,713

(22) Filed: Feb. 6, 2024

(30) Foreign Application Priority Data
Mar. 16, 2023 (JP) 2023-042204

(51) Int. Cl. G07C 9/00; E05B 47/00

(52) U.S. Cl. CPC G07C 9/00944; E05B 47/0012; E05B 2047/002

(57) ABSTRACT

A key container includes a housing that accommodates an electronic key, an actuator that produces motion in a first direction and motion in a second direction that is opposite to the first direction in order to selectively operate buttons arranged on the electronic key, and a drive mechanism configured to produce motion in the first direction with the actuator and operate a first button that is one of the buttons and configured to produce motion in the second direction with the actuator to operate a second button that is one of the buttons.

### BACKGROUND

### Field

The following description relates to a key container that accommodates and operates an electronic key.

### Description of Related Art

Japanese Laid-Open Patent Publication No. 2022-113329 discloses an in-vehicle device that accommodates an electronic key of a vehicle. The in-vehicle device is mounted on a shared vehicle. The in-vehicle device includes actuators and intermediate members. The actuators are used to push buttons of the accommodated electronic key. The intermediate members are used to transmit force for pushing the buttons. The in-vehicle device activates an actuator and pushes the corresponding button of the electronic key with the intermediate member to operate the vehicle.

In Japanese Laid-Open Patent Publication No. 2022-113329, an actuator is provided for each button of the electronic key. This may enlarge the in-vehicle device.

### SUMMARY

In one general aspect a key container includes a housing configured to accommodate an electronic key, an actuator configured to produce motion in a first direction and motion in a second direction that is opposite to the first direction in order to selectively operate buttons arranged on the electronic key, and a drive mechanism configured to produce motion in the first direction with the actuator to operate a first button that is one of the buttons and configured to produce motion in the second direction with the actuator to operate a second button that is one of the buttons.

Other features and aspects will be apparent from the following detailed description, the drawings, and the claims.

### BRIEF DESCRIPTION OF THE DRAWINGS

FIGS. 1A and 1B are perspective views showing one embodiment of a key container.

FIG. 2 is a schematic diagram showing a remote operation performed on the key accommodating apparatus with the terminal.

FIG. 3 is a diagram showing the electrical configuration of the key container.

FIG. 4 is an exploded perspective view of the key container.

FIG. 5 is an exploded perspective view of a drive unit.

FIG. 6 is an exploded perspective view of a drive mechanism.

FIG. 7 is a cross-sectional view taken along line VII-VII in FIG. 4.

FIG. 8 is a perspective view showing a lower side of the drive mechanism.

FIG. 9 is a plan view showing the interior of an upper housing.

FIGS. 10A and 10B are diagrams illustrating the connection of connectors when a tray is connected.

FIGS. 11A and 11B are diagrams illustrating motions produced by the drive mechanism.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

One embodiment of the present disclosure will now be described.

### Key Container 1

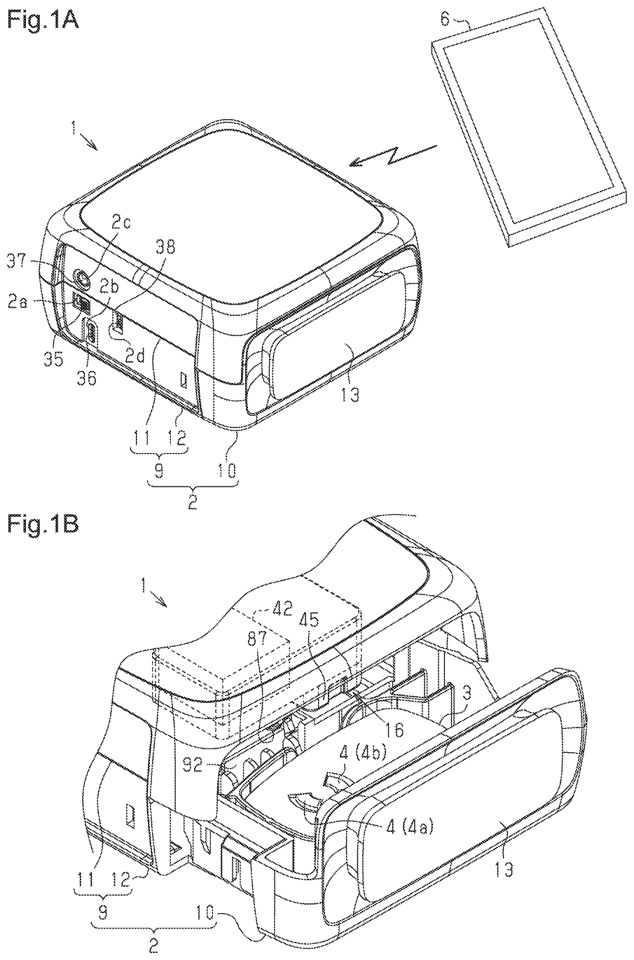

As shown in FIGS. 1A and 1B, a key container 1 includes a housing 2 that accommodates an electronic key 3 (refer to FIG. 1B). The electronic key 3 includes buttons 4 used to remotely operate a vehicle 5. The buttons 4 include, for example, a first button 4a and a second button 4b. The first button 4a is, for example, a door lock button used to lock a door (e.g., vehicle door). The second button 4b is, for example, a door unlock button used to unlock the door (e.g., vehicle door). The buttons 4 may be, for example, push buttons. The electronic key 3 transmits signals in, for example, the ultrahigh frequency (UHF) band.

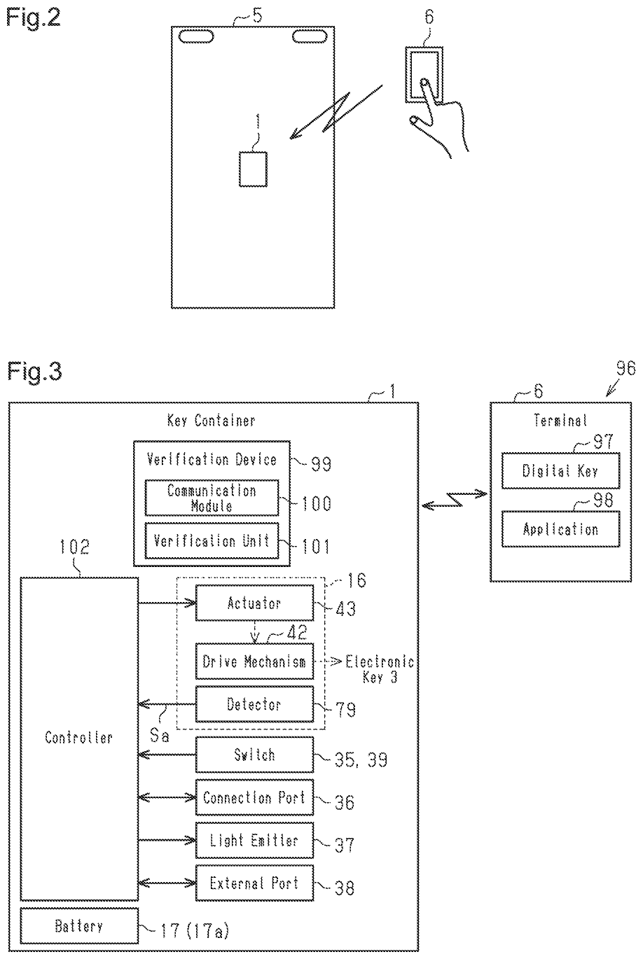

Referring to FIG. 2, the key container 1 is arranged, for example, in the passenger component of the vehicle 5. Preferably, the key container 1 is arranged in a concealed location, for example, inside the dashboard, under a seat, or inside the trunk. The vehicle 5 is, for example, a shared car or rented car. In this manner, the vehicle 5 that includes the key container 1 is used by a third party that receives permission.

The key container 1 is remotely operated by a terminal 6 to operate the buttons 4 of the electronic key 3. The terminal 6 may be, for example, a high-performance mobile phone such as a smartphone, a wearable terminal, or a tablet terminal. In this manner, the terminal 6 actuates the key container 1 to operate the buttons 4 of the electronic key 3. This, in turn, operates the vehicle 5.

### Components of Key Container 1

As shown in FIGS. 1A and 1B, the housing 2 includes a housing body 9, which is the main body of the housing 2, and a tray 10, which is coupled to the housing body 9. The housing body 9 includes, for example, an upper housing 11 and a lower housing 12. The electronic key 3 is settable in the tray 10. A handle 13 that can be held with a hand is arranged on the front surface of the tray 10. The tray 10 may be movable to open or close the housing body 9. Alternatively, the tray 10 may be fixed to the housing body 9 so that it cannot open or close the housing body 9.

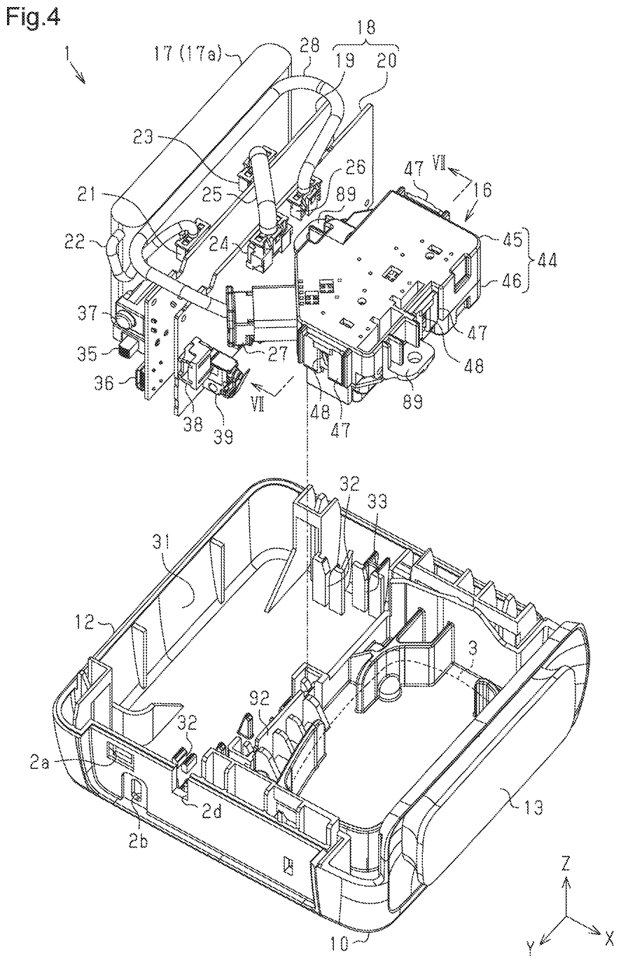

As shown in FIG. 4, the key container 1 includes a drive unit 16, a battery 17, and substrates 18. The drive unit 16 is used to operate the buttons 4 of the electronic key 3 that is set in the tray 10. The battery 17 is, for example, a plate-shaped battery 17a used as a power supply of the key container 1. The substrates 18 includes a circuit (not shown) that actuates the drive unit 16 with electric power from the battery 17. The substrates 18 include, for example, a power substrate 19, which controls the power supply of the key container 1, and a control substrate 20, which controls and actuates the drive unit 16.

The power substrate 19 is supplied with electric power from the battery 17 through a cable 22 connected to a first connector 21 of the power substrate 19. The power substrate 19 supplies electric power to the control substrate 20 through a cable 25 including one end connected to a second connector 23 of the power substrate 19 and another end connected to a first connector 24 of the control substrate 20. The control substrate 20 is electrically connected to the drive unit 16 by a cable 28 including one end connected to a second connector 26 of the control substrate 20 and another end connected to an external connector 27 of the drive unit 16.

### Orientation of Battery 17 and Substrate 18

As shown in FIG. 4, the battery 17 and the substrate 18 are held upright inside the housing 2. In this example, the battery 17, the power substrate 19, and the control substrate 20 are arranged along three lines inside the housing 2. The battery 17 is coupled to a battery coupling portion 31 inside the lower housing 12. The power substrate 19 is fixed to power substrate coupling portions 32 inside the housing 2. The control substrate 20 is fixed to control substrate coupling portions 33 inside the housing 2.

Preferably, the power substrate coupling portions 32 are formed on, for example, the inner surfaces of both the upper housing 11 and the lower housing 12. FIG. 4 only shows two power substrate coupling portions 32 in the lower housing 12. Preferably, the control substrate coupling portions 33 are also formed on, for example, the inner surfaces of both the upper housing 11 and the lower housing 12. FIG. 4 only shows one control substrate coupling portion 33 in the lower housing 12.

### Components Mounted on Substrate 18

As shown in FIG. 4, the key container 1 includes a switch 35, a connection port 36, and a light emitter 37. The switch 35, the connection port 36, and the light emitter 37 are mounted on, for example, the power substrate 19. The switch 35 is, for example, a power switch. The switch 35 may be, for example, a slide switch, a push switch, a toggle switch, a rotary switch, a seesaw switch, a microswitch, or the like. The switch 35 is, for example, exposed to the outside of the housing 2 through an opening 2a of the housing 2.

The connection port 36 is, for example, a USB port. For example, a charge cable for charging the battery 17, a communication cable for communication with the power substrate 19, or the like is connected to the connection port 36. The connection port 36 is, for example, exposed to the outside of the housing 2 through an opening 2b of the housing 2.

The light emitter 37 is, for example, a light emitting diode (LED). The light emitter 37 is illuminated, for example, in accordance with the state of the key container 1. For example, the light emitter 37 is continuously illuminated when the power supply of the key container 1 is on and intermittently illuminated when the battery 17 is being charged. The light emitter 37 is, for example, exposed to the outside of the housing 2 through an opening 2c (refer to FIG. 1A) of the housing 2.

The key container 1 includes an external port 38 and a switch 39. The external port 38 is used, for example, to connect a communication cable (not shown) extending from an internet communication device (not shown) arranged in the vehicle 5. The external port 38 is, for example, exposed to the outside of the housing 2 through an opening 2d of the housing 2.

The switch 39 detects the tray 10 coupled to the housing body 9. The switch 39 is activated when the tray 10 is coupled to the housing body 9 and deactivated when the tray 10 is not coupled to the housing body 9. The switch 39 may be, for example, a microswitch.

### Drive Mechanism 42

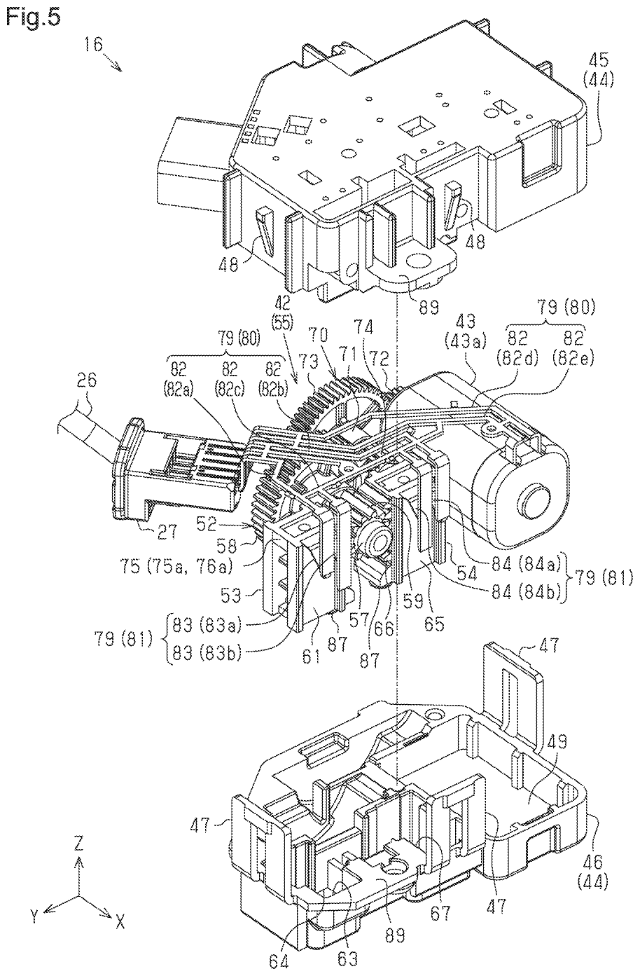

As shown in FIG. 5, the key container 1 includes a drive mechanism 42 that selectively operates the buttons 4 of the accommodated electronic key 3 with an actuator 43. The drive mechanism 42 is accommodated inside a case 44 of the drive unit 16. The case 44 includes, for example, an upper case 45 and a lower case 46. The upper case 45 and the lower case 46 are coupled together by a structure in which slotted pieces 47 are interlocked with corresponding protrusions 48.

The drive mechanism 42 produces motion in a first direction with the actuator 43 to operate the first button 4a of the electronic key 3 and produces motion in a second direction, which is opposite the first direction, with the actuator 43 to operate the second button 4b of the electronic key 3. The actuator 43 is, for example, a motor 43a. For example, the drive mechanism 42 drives the motor 43a to produce rotation in the first direction and produce rotation in the second direction. The actuator 43 is accommodated in, for example, an actuator compartment 49 of the case 44. FIG. 5 shows the part of the actuator compartment 49 in the lower case 46. The drive unit 16 is, for example, a single assembly unit integrating the drive mechanism 42 and the actuator 43.

### Rack and Pinion Structure of Drive Mechanism 42

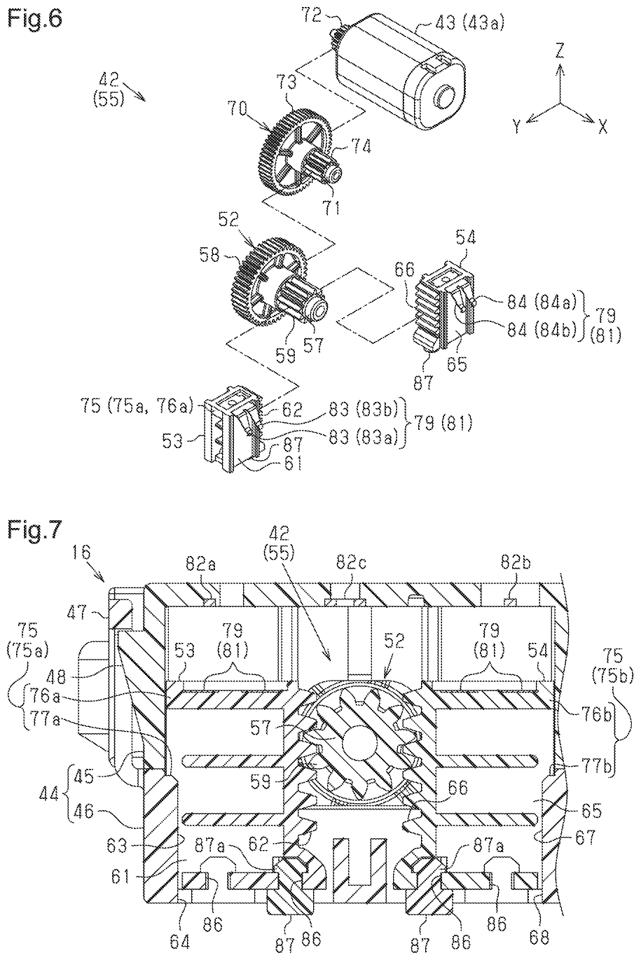

As shown in FIGS. 5 and 6, the drive mechanism 42 includes a gear mechanism 55. In one example, the gear mechanism 55 includes a pinion 52, which is rotated by the actuator 43, a first rack 53, which operates the first button 4a when the pinion 52 is rotated in one direction, and a second rack 54, which operates the second button 4b when the pinion 52 is rotated in the other direction. As described above, one example of the drive mechanism 42 is the gear mechanism 55 with the rack and pinion structure.

As shown in FIG. 5, the pinion 52 includes a rotation shaft 57 extending in one direction (X-axis direction in FIG. 5) of the drive mechanism 42 in plan view. In one example, the rotation shaft 57 extends parallel to the rotation shaft of the motor 43a. The rotation shaft 57 is supported in the case 44 in a rotatable manner. In this example, the rotation shaft 57 is supported by the upper case 45 and the lower case 46 in a rotatable manner. The pinion 52 includes a large-diameter gear 58 and a small-diameter gear 59, which is coaxial with the large-diameter gear 58.

The first rack 53 includes a rack body 61, which forms the main part of the first rack 53, and straight teeth 62, which are meshed with the pinion 52. The straight teeth 62 are arranged on one side of the rack body 61. The first rack 53 is accommodated in a first rack compartment 63 of the case 44 in a manner allowing for linear reciprocation in the height direction (Z-axis direction in FIG. 5). The first rack compartment 63 includes an inner space defined between the upper case 45 and the lower case 46. The bottom of the first rack compartment 63 includes an opening 64 through which an end of the first rack 53 is exposed to the outside of the case 44. The opening 64 extends through the bottom surface of the lower case 46.

The second rack 54 includes a rack body 65, which forms the main part of the second rack 54, and straight teeth 66, which are meshed with the pinion 52. The straight teeth 66 are arranged on one side of the rack body 65. The straight teeth 66 of the second rack 54 face the straight teeth 62 of the first rack 53. The second rack 54 is accommodated in a second rack compartment 67 of the case 44 in a manner allowing for linear reciprocation in the height direction (Z-axis direction in FIG. 5). In the same manner as the first rack compartment 63, the second rack compartment 67 includes an inner space defined between the upper case 45 and the lower case 46. The bottom of the second rack compartment 67 includes an opening 68 (refer to FIG. 7) through which an end of the second rack 54 is exposed to the outside of the case 44. The second rack compartment 67 is located adjacent to the first rack compartment 63. The first rack 53 and the second rack 54 are meshed with the same small-diameter gear 59 of the pinion 52.

As shown in FIGS. 5 and 6, the drive mechanism 42 includes a reduction gear 70 that reduces the speed of the motion produced by the drive force of the actuator 43 and transmits the decelerated motion to the pinion 52. The reduction gear 70 includes a rotation shaft 71 extending in one direction (X-axis direction in FIG. 5) of the drive mechanism 42 in plan view. In one example, the rotation shaft 71 extends parallel to the rotation shaft 57 of the pinion 52. The rotation shaft 71 is supported inside the case 44 in a rotatable manner. In this example, the rotation shaft 71 is supported by the upper case 45 and the lower case 46 in a rotatable manner. The reduction gear 70 includes a large-diameter gear 73, which is meshed with a gear 72 on the shaft end of the actuator 43, and a small-diameter gear 74, which is meshed with the large-diameter gear 58 of the pinion 52.

As shown in FIG. 7, the drive mechanism 42 includes a stopper 75 that prevents separation of the first rack 53 and the second rack 54 from the case 44. The stopper 75 includes a first stopper 75a, which prevents separation of the first rack 53, and a second stopper 75b, which prevents separation of the second rack 54. The first stopper 75a includes a projection 76a, which is formed by an upper wall portion of the first rack 53, and a case wall portion 77a, which is defined by the inner surface of the case 44. The projection 76a can come into contact with the case wall portion 77a. The second stopper 75b includes a projection 76b, which is formed by an upper wall portion of the second rack 54, and a case wall portion 77b, which is defined by the inner surface of the case 44. The projection 76b can come into contact with the projection 76b. In this example, contact of the lower end of the projection 76a with the upper end of the case wall portion 77a prevents separation of the first rack 53. In the same manner, contact of the lower end of the projection 76b with the upper end of the case wall portion 77b prevents separation of the second rack 54.

### Detector 79

As shown in FIG. 5, the key container 1 includes a detector 79 that detects motion produced by the drive mechanism 42. The detector 79 includes, for example, a fixed contact 80 and a movable contact 81. The fixed contact 80 includes, for example, flat wires 82. The flat wires 82 include, for example, a first detection wire 82a, a second detection wire 82b, a ground wire 82c, a positive terminal wire 82d, and a negative terminal wire 82e.

The movable contact 81 includes, for example, a first movable contact 83, which is arranged on the first rack 53, and a second movable contact 84, which is arranged on the second rack 54. The first movable contact 83 includes, for example, two contact pieces, namely, a first contact portion 83a and a second contact portion 83b. The first contact portion 83a detects, for example, an unlock operation performed on the electronic key 3. The second contact portion 83b is used for ground (GND). The second movable contact 84 also includes, for example, two contact pieces, namely, a first contact portion 84a and a second contact portion 84b. The first contact portion 84a detects, for example, a lock operation performed by the electronic key 3. The second contact portion 84b is used for ground (GND).

The first detection wire 82a includes one end that can come into contact with the first contact portion 83a of the first movable contact 83 and another end that is connected to the external connector 27. The second detection wire 82b includes one end that can come into contact with the first contact portion 84a of the second movable contact 84 and another end that is connected to the external connector 27. The ground wire 82c includes one end that is in contact with the second contact portion 83b of the first movable contact 83 and the second contact portion 84b of the second movable contact 84 and another end that is connected to the external connector 27. The positive terminal wire 82d includes one end connected to the positive terminal of the motor 43a and another end connected to the external connector 27. The negative terminal wire 82e includes one end connected to the negative terminal of the motor 43a and another end connected to the external connector 27.

### Pusher Coupling Portion 86

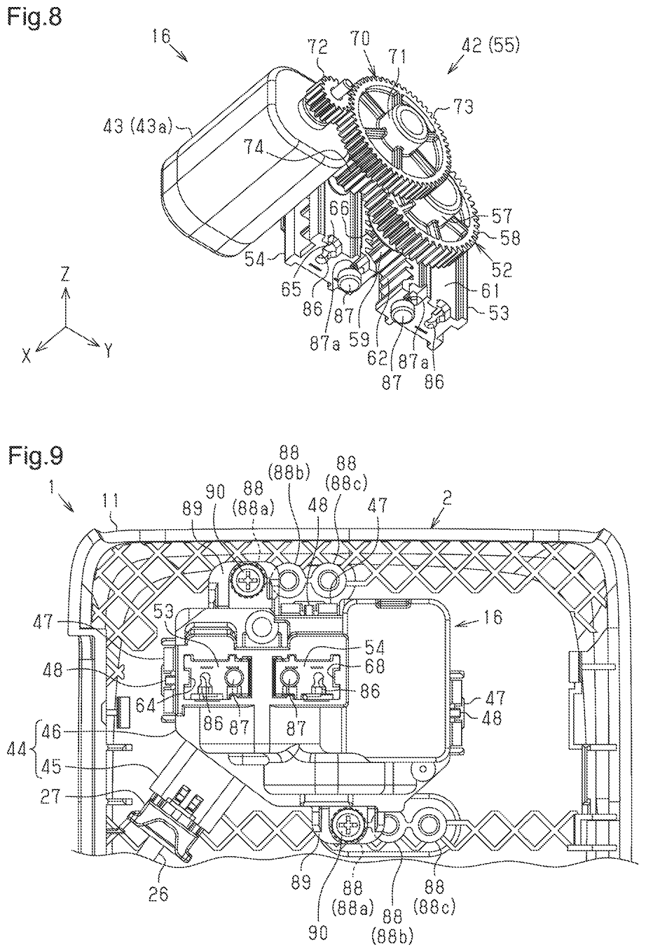

As shown in FIGS. 7 and 8, at least one of (e.g., both) the first rack 53 and the second rack 54 includes pusher coupling portions 86 at pusher coupling portions. In this example, the first rack 53 includes a plurality of (e.g., two) pusher coupling portions 86. The second rack 54 also includes a plurality of (e.g., two) pusher coupling portions 86. The drive mechanism 42 includes a pusher 87 that is coupled to one of the pusher coupling portions 86 of the first rack 53 and is movable so as to come into contact with the first button 4a. The drive mechanism 42 also includes another pusher 87 that is coupled to one of the pusher coupling portions 86 of the second rack 54 and is movable so as to come into contact with the second button 4b. Each of the pusher coupling portions 86 is, for example, an engagement hole including an insertion slit. Each pusher 87 is guided by the insertion slit and inserted into the engagement hole of the corresponding pusher coupling portion 86. Each pusher 87 includes a protruding end 87a. The protruding end 87a is engaged with an edge of the engagement hole of the corresponding pusher coupling portion 86. This couples the pusher 87 to the pusher coupling portion 86.

### Unit Coupling Portion 88

As shown in FIG. 9, the housing 2 includes one or more unit coupling portions 88 to couple the drive unit 16 to the housing 2. The drive unit 16 is, for example, fixed to the housing 2 by fastening coupling tabs 89 of the case 44 with fasteners 90 to one of the unit coupling portions 88. The fasteners 90 are, for example, screws.

In one example, the housing 2 includes a plurality of (e.g., three) unit coupling portions 88 at a plurality of unit coupling positions. In this example, the unit coupling portions 88 include a first unit coupling portion 88a, which is located at the leftmost side in FIG. 9, a second unit coupling portion 88b, which is located next to the first unit coupling portion 88a, and a third unit coupling portion 88c, which is located next to the second unit coupling portion 88b.

### Connection of Connectors When Tray 10 is Connected

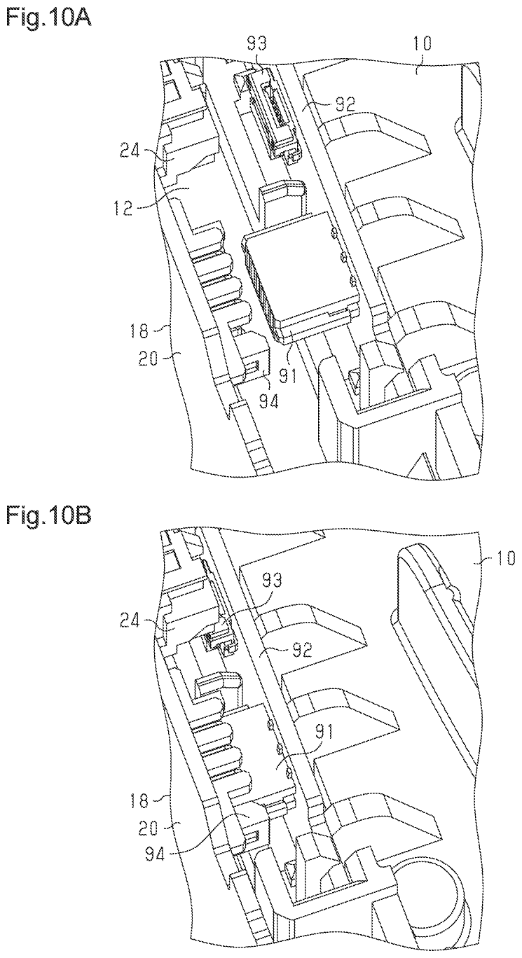

As shown in FIGS. 10A and 10B, the tray 10 includes a tray connector 91 that is electrically connectable one of the substrates 18 (in this example, control substrate 20) in the housing body 9. The tray connector 91 is arranged on a tray substrate 92 that is attached to the tray 10. The tray connector 91 is electrically connected to the electronic key 3 that is set in the tray 10 by a key connector 93 arranged on the tray substrate 92. For example, a power line (not shown) extending from the electronic key 3 is connected to the key connector 93 to supply power to the electronic key 3.

The housing body 9 includes a housing body connector 94 that becomes electrically connected to the tray connector 91 when the tray 10 is coupled to the housing body 9. The housing body connector 94 is arranged on one of the substrates 18 (in this example, control substrate 20) in the housing body 9. In this manner, when coupling the tray 10 to the housing body 9, the tray connector 91 and the housing body connector 94 will also be connected at the same time. The housing body connector 94 is used to, for example, supply power to the electronic key 3 that is set in the tray 10.

### Digital Key System 96

As shown in FIG. 3, the key container 1 includes a digital key system 96 that allows the key container 1 to be actuated with the terminal 6 to which a digital key 97 is registered. An application 98 that allows the terminal 6 to be used to actuate the key container 1 is registered to the terminal 6. The application 98 may be registered in advance to the terminal 6 or downloaded from an external device (not shown).

The terminal 6 downloads the unique digital key 97 from an external device (not shown) so that it can actuate the key container 1. A management device (not shown), for example, manages the digital key 97 and distributes the digital key 97 through network communication to the terminal 6. Preferably, the digital key 97 is, for example, a one-time key that can be used only once or only during a certain period.

The digital key system 96 includes a verification device 99 that establishes wireless communication with the terminal 6 and verifies the terminal 6. The verification device 99 includes a communication module 100 that establishes communication with the terminal 6. Communication between the terminal 6 and the communication module 100 is, for example, short-range wireless communication. Short-range wireless communication may be Personal Area Network (PAN) or near-field communication. Examples of Personal Area Network communication include, for example, Bluetooth® communication, Ultra-Wideband (UWB) communication, and Wi-Fi®. Bluetooth® communication includes Bluetooth Low Energy (BLE).

The verification device 99 includes a verification unit 101 that verifies the digital key 97 of the terminal 6. The verification unit 101 determines whether the digital key 97, which is acquired from the terminal 6, can be correctly decoded to verify the authenticity of the digital key 97. The verification of the digital key 97 does not necessarily have to use a cryptographic key code and may use, for example, ID verification or a hash function. ID verification, for example, compares a predetermined code with an answer. Hash function, for example, uses a hash value for verification. The digital key 97 is, for example, encrypted with a key code corresponding to the verification device 99.

When acquiring the digital key 97 from the terminal 6 through wireless communication, the verification unit 101 verifies the digital key 97. When the digital key 97 acquired from the terminal 6 is satisfied, the verification unit 101 permits actuation of the key container 1. This allows the key container 1 to operate the electronic key 3 with the drive mechanism 42.

### Controller 102 of Key Container 1

As shown in FIG. 3, the key container 1 includes a controller 102 that controls operation of the key container 1. The controller 102 includes, for example, a micro-processing unit (MPU), a central processing unit (CPU), and various types of memories. The controller 102 includes, for example, a circuit arranged on the control substrate 20. The controller 102 is connected to the actuator 43 and the detector 79. The controller 102 controls the actuator 43 in accordance with a detection signal Sa of the detector 79. The controller 102 also manages the switches 35 and 39, the light emitter 37, the connection port 36, the external port 38, and the like.

The operation of the present embodiment will now be described.

### Operation of Key Container 1

Referring to FIG. 2, when locking the door of the vehicle 5, the application 98 is opened on the terminal 6. Then, an unlock button shown on the screen of the terminal 6 is operated. When the unlock button on the terminal 6 is operated, the terminal 6 sends an unlock request to the key container 1 through short-range communication. When the communication module 100 of the verification device 99 receives the unlock request from the terminal 6, of which the digital key 97 has been verified, the key container 1 performs an unlock operation on the electronic key 3 in response to the unlock request.

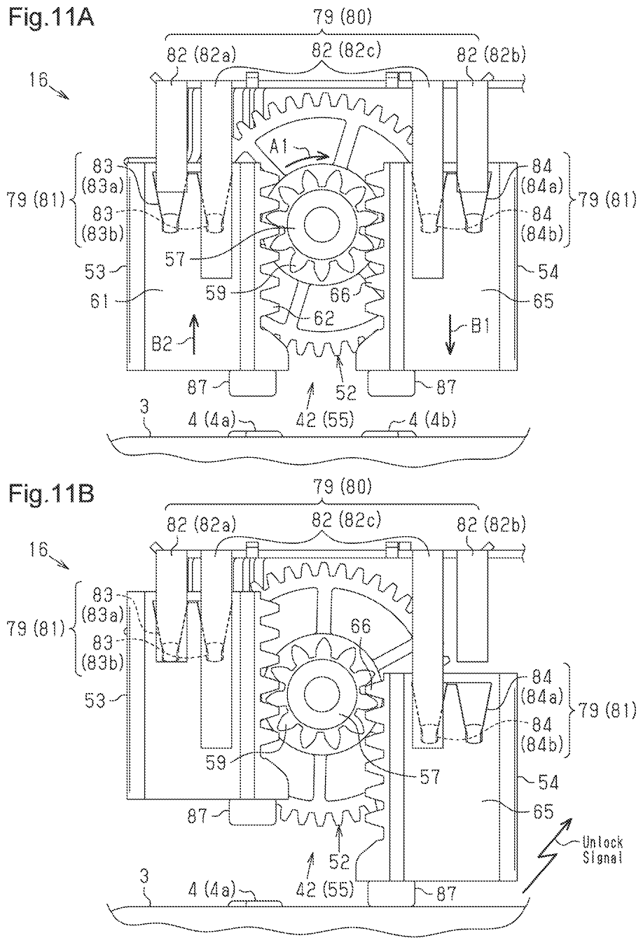

As shown in FIG. 11A, when performing an unlock operation with the electronic key 3, the controller 102 produces rotation in one direction with the motor 43a, which is the actuator 43, to rotate the pinion 52 about the rotation shaft 57 in an unlock direction (direction of arrow A1 in FIG. 11A). When the pinion 52 is rotated in the unlock direction, the second rack 54 moves linearly toward the electronic key 3 (direction of arrow B1 in FIG. 11A). When the pinion 52 is rotated in the unlock direction, the first rack 53 moves linearly away from the electronic key 3 (direction of arrow B2 in FIG. 11A). In this matter, rotation of the motor 43a moves the first rack 53 and the second rack 54 linearly in opposite directions.

As shown in FIG. 11B, when the second rack 54 moves linearly to the lowermost position, the end of the pusher 87 on the second rack 54 pushes the second button 4b of the electronic key 3, which is the unlock button. Consequently, the electronic key 3 sends an unlock signal to the vehicle 5. When the vehicle 5 receives the unlock signal, the vehicle 5 unlocks the door. This allows the user who operated the terminal 6 to enter the vehicle 5.

The controller 102 determines the position of each of the first rack 53 and the second rack 54 from the detection signal Sa of the detector 79. An unlock operation will result in the first contact portion 83a of the first movable contact 83 coming into contact with the first detection wire 82a. This activates the first movable contact 83. Further, the first contact portion 84a of the second movable contact 84 will not be in contact with the second detection wire 82b. Thus, the second movable contact 84 will be deactivated. When activation of the first movable contact 83 and deactivation of the second movable contact 84 are detected, the controller 102 determines that the second rack 54 has reached the lowermost position. The controller 102 stops the motor 43a when the second rack 54 reaches the lowermost point. This ends the unlock operation of the drive mechanism 42.

When determining that the second rack 54 has reached the lowermost position, the controller 102 produces rotation in the reverse direction with the motor 43a. This moves the second rack 54 linearly away from the electronic key 3 and moves the first rack 53 linearly toward the electronic key 3. When the first movable contact 83 (first contact portion 83a) is deactivated and the second movable contact 84 (first contact portion 84a) is deactivated, the controller 102 stops the motor 43a. In this state, the first rack 53 and the second rack 54 are returned to their original initial positions (state of FIG. 11A).

When the detector 79 remains deactivated (activation of first movable contact 83 remains undetected) for a certain period during an unlock operation even though the drive mechanism 42 has been actuated, the controller 102 may return the drive mechanism 42 to an initial state prior to actuation. The initial state of the drive mechanism 42 corresponds to, for example, a state in which the first rack 53 and the second rack 54 are in their original initial positions. As an example, if the second rack 54 is not detected at the lowermost position even though the certain period elapses from the beginning of the unlock action, the rotation of the motor 43a may be reversed to return the second rack 54 to its original initial position. Thus, if the second rack 54 becomes unmovable when for example, becoming caught on the wall surface of the second rack compartment 67, the second rack 54 is returned to its original initial position so that the unlock operation can be performed once more.

The operation for locking the door of the vehicle 5 is reverse the operation for unlocking the door but basically the same. More specifically, when locking the door, the motor 43a, the pinion 52, the first rack 53, the second rack 54, and the reduction gear 70 each produce motion in a direction reversed from that produced when unlocking the door. Thus, the door unlock operation will not be described.

### Merit of Rack and Pinion Structure

As shown in FIGS. 5 and 6 of this example, the drive mechanism 42 that operates the buttons 4 of the electronic key 3 in the key container 1 is a rack and pinion structure. Thus, the first button 4a and the second button 4b can be selectively operated with the same rack and pinion structure. As a result, the drive mechanism 42 does not have to be provided for each of the first button 4a and the second button 4b. This allows the key container 1 to be reduced in size.

The drive mechanism 42 is a rack and pin structure, that is, a coupling structure using a straight gear. More specifically, the straight teeth are coupled to two locations that are where the gear 72 of the actuator 43 is meshed with the reduction gear 70 and where the pinion 52 is meshed with the reduction gear 70. This improves the drive force transmission efficiency compared with, for example, a worm helical gear or the like. Thus, the buttons 4 can be operated with a sufficient load. Further, the first rack 53 and the second rack 54 push and operate the buttons 4 in a vertical direction. Thus, the buttons 4 can be operated with sufficient torque.

### Application to Variations of Electronic Key 3

As shown in FIGS. 7 and 8, the first rack 53 and the second rack 54 each include a plurality of the pusher coupling portions 86 at a plurality of coupling portions for the pusher 87. The tray 10, in which the electronic key 3 is set, is provided in a number of types. The buttons 4 are arranged in a pattern that differs in accordance with the type of the electronic key 3. In this example, the pushers 87 can be coupled to the pusher coupling portions 86 in correspondence with the buttons 4 of the electronic key 3. This allows for application to different types of the electronic key 3.

As shown in FIG. 9, the housing 2 includes a plurality of the unit coupling portions 88 at a plurality of coupling portions for the drive unit 16. Thus, even when a different electronic key 3 is set in the tray 10 and the arrangement of the buttons 4 on the electronic key 3 is different, the coupling position of the drive unit 16 can be changed. This allows for application to different types of the electronic key 3.

### Power Supply of Electronic Key 3

Referring to FIGS. 10A and 10B, when the tray connector 91 is connected to the housing body connector 94, a power supply line is formed extending from the battery 17 to the electronic key 3. The controller 102 starts supplying electric power through the power supply line to the electronic key 3 when receiving a power supply permission notification from an external server (not shown) through the external port 38. Preferably, the power supply permission notification is provided when an alcohol detector allows the user to enter the vehicle The electronic key 3 is actuated by the electric power from the battery 17.

The power supply of the electronic key 3 is not limited to the battery 17 of the key container 1. For example, when a battery is incorporated in the electronic key 3, the battery may be used as the power supply. In this case, for example, the tray connector 91, the tray substrate 92, the housing body connector 94, and the like may be omitted.

### Advantages of Embodiment

The above embodiment has the advantages described below.
(1) The key container 1 includes the housing 2, which accommodates the electronic key 3, and the actuator 43, which produces motion in the first direction and motion in the second direction, which is opposite the first direction, in order to selectively operate the buttons 4 arranged on the electronic key 3. The key container 1 further includes the drive mechanism 42. The drive mechanism 42 produces motion in the first direction with the actuator 43 to operate the first button 4a and produces motion in the second direction with the actuator 43 to operate the second button 4b.

In this structure, the first button 4a and the second button 4b of the electronic key 3, which is accommodated in the key container 1, are both operated with the same drive mechanism 42. Thus, the drive mechanism 42 does not have to be provided for each of the first button 4a and the second button 4b. This allows the key container 1 to be reduced in size.
(2) The key container 1 includes the drive unit 16 integrating the drive mechanism 42 and the actuator 43. This allows the drive mechanism 42 and the actuator 43 to be integrated into a single assembly unit and improves the assembling efficiency of the key container 1.
(3) The housing 2 includes the unit coupling portions 88 at unit coupling positions. The drive unit 16 is coupled to one of the unit coupling portions 88. With this structure, the buttons 4 of the electronic key 3, which is accommodated in the key container 1, may be located at different positions.
(4) The drive mechanism 42 includes the gear mechanism 55. The gear mechanism 55 includes the pinion 52, which is rotated by the actuator 43, the first rack 53, which operates the first button 4a when the pinion 52 is rotated in one direction, and the second rack 54, which operates the second button 4b when the pinion 52 is rotated in the other direction. In this structure, the drive mechanism 42 is a rack and pinion structure. Thus, the drive mechanism 42 has a simple structure.
(5) The drive mechanism 42 includes the reduction gear 70 that reduces the speed of the motion produced by the drive force of the actuator 43 and transmits the decelerated motion to the pinion 52. With this structure, the drive force of the actuator 43 is transmitted by the reduction gear 70 to the pinion 52. This allows the pinion 52 to be moved linearly with high torque. Thus, the first rack 53 and the second rack 54, which are large loads, can be moved with high torque to operate the buttons 4.
(6) At least one of the first rack 53 and the second rack 54 includes the pusher coupling portions 86 at pusher coupling portions. The drive mechanism 42 includes the pusher 87 that is coupled to one of the pusher coupling portions 86 to operably contact the corresponding button 4. With this structure, the buttons 4 of the electronic key 3, which is accommodated in the key container 1, may be located at different positions.
(7) The key container 1 includes the detector 79, which detects motion produced by the drive mechanism 42, and the controller 102, which controls actuation of the actuator 43 based on the detection signal Sa of the detector 79. This structure allows the detector 79 and the controller 102 to be integrated in the key container 1.
(8) The detector 79 is activated when the drive mechanism 42 operates one of the buttons 4. When the detector 79 remains deactivated for a certain period even though the drive mechanism 42 was activated, the controller 102 returns the drive mechanism 42 to the initial state prior to actuation. With this structure, when a motion produced by the drive mechanism 42 cannot be completed in a normal manner, the drive mechanism 42 will not be left unattended.
(9) The key container 1 includes the housing body 9, which is the main body of the housing 2, and the tray 10, which is couplable to the housing body 9 and is configured to allow for the electronic key 3 to be set therein. The key container 1 includes the tray connector 91 and the housing body connector 94. The tray connector 91, which is arranged on the tray 10, is electrically connectable to the electronic key 3. The housing body connector 94, which is arranged on the housing body 9, is configured to be electrically connected to the tray connector 91 when the tray 10 is coupled to the housing body 9. With this structure, the tray connector 91 and the housing body connector 94 are connected at the same time as when the tray 10 is coupled to the housing body 9. This improves convenience.
(10) The key container 1 includes the plate-shaped battery 17a, which serves as the battery supply, and the substrate 18 that includes a circuit for actuating the drive mechanism 42 with the electric power from the plate-shaped battery 17a. The battery 17a and the substrate 18 are held upright inside the housing 2. With this structure, the plate-shaped battery 17a and the substrate 18 can be arranged next to each other. If, for example, the plate-shaped battery 17a and the substrate 18 were to be arranged one over the other (i.e., arranged horizontally), each of the plate-shaped battery 17a and the substrate 18 would have to be arranged in a different compartment. This would enlarge the size of key container 1. In contrast, such separate components do not have to be provided in the key container 1. This allows the key container 1 to be reduced in size.

### OTHER EMBODIMENTS

The present embodiment may be modified as described below. The above embodiment and the following modifications can be combined as long as there is no technical contradiction.

In each of the first rack 53 and the second rack 54, the gear portion meshed with the pinion 52 may be a component separate from the portion that operates the corresponding button 4.

The unit coupling portions 88 do not have to be a screw-fastening structure and may be a different structure, for example, a snap-fit structure.

The pusher coupling portions 86 may be modified to a structure that differs from the structure of the illustrated embodiment.

The drive mechanism 42 and the actuator 43 do not have to form an assembly unit and may be separate parts.

The actuator 43 does not have to be the motor 43a and may be a different member.

The drive mechanism 42 does not have to be the gear mechanism 55, which is a rack and pinions structure, and may be a different structure.

The drive mechanism 42 does not have to be the gear mechanism 55 and may be another mechanical structure.

The reduction gear 70 is not limited to one stage and may include plural stages.

The detector 79 may use, for example, a sensor instead of a contact. Examples of a sensor include an optical sensor and a magnetic sensor.

The battery 17 is not limited to the plate-shaped battery 17a and may be, for example, a cylindrical battery, a packed battery, a coin battery, a prismatic battery, or the like.

The electronic key 3 is not limited to two buttons 4 and may include three or more buttons.

The electronic key 3 is not limited to a smart key and may be a wireless key.

The key container 1 is not limited to use with the vehicle 5 and may be used with products of other fields.

The controller 102 may each be implemented by 1) one or more processors that run on computer programs (software) or 2) a combination of such processors and one or more dedicated hardware circuits such as application-specific integrated circuits (ASICs) that execute at least some of various types of processes. The processors include a CPU and a memory such as a RAM and a ROM, and the memory stores program codes or instructions configured to have the CPU execute processes. The memory, namely, a computer readable medium, includes any available medium that is accessible by a versatile or dedicated computer. Instead of a computer including the above processors, processing circuitry including one or more dedicated hardware circuits may be used to execute the processes described above.

The present disclosure is illustrated through the embodiment. However, the present disclosure is not limited to the structure of the embodiment. The present disclosure includes various modified examples and modifications within the scope of equivalence. Additionally, various combinations and modes and one, more, or less of these elements in other combinations and forms are included in the range and conceptual scope of the present disclosure.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A key container, comprising:
a housing configured to accommodate an electronic key;
an actuator configured to produce motion in a first direction and motion in a second direction that is opposite to the first direction in order to selectively operate buttons arranged on the electronic key; and
a drive mechanism configured to produce motion in the first direction with the actuator to operate a first button that is one of the buttons and configured to produce motion in the second direction with the actuator to operate a second button that is one of the buttons.

2. The key container according to claim 1, comprising a drive unit that is a single assembly unit integrating the drive mechanism and the actuator.

3. The key container according to claim 2, wherein:
the housing includes unit coupling portions at unit coupling positions; and
the drive unit is coupled to one of the unit coupling portions.

4. The key container according to claim 1, wherein:
the drive mechanism includes a gear mechanism;
the gear mechanism includes
a pinion configured to be rotated by the actuator,
a first rack configured to operate the first button when the pinion is rotated in one direction, and
a second rack configured to operate the second button when the pinion is rotated in another direction.

5. The key container according to claim 4, wherein the drive mechanism further includes a reduction gear configured to decelerate a motion produced by drive force of the actuator and transmit the decelerated motion to the pinion.

6. The key container according to claim 4, wherein:
at least one of the first rack and the second rack includes pusher coupling portions at pusher coupling positions; and
the drive mechanism includes a pusher that is coupled to one of the pusher coupling portions to operably contact a corresponding one of the first button and the second button.

7. The key container according to claim 1, further comprising:
a detector configured to detect motion produced by the drive mechanism; and
a controller configured to control actuation of the actuator based on a detection signal of the detector.

8. The key container according to claim 7, wherein:
the detector is activated when the drive mechanism operates one of the buttons; and
the controller is configured to, when the detector remains deactivated for a certain period even though the drive mechanism has been actuated, return the drive mechanism to an initial state prior to actuation.

9. The key container according to claim 1, further comprising:
a housing body that is a main body of the housing;
a tray that is couplable to the housing body and is configured to allow for the electronic key to be set therein;
a tray connector that is arranged on the tray and is electrically connectable to the electronic key; and
a housing body connector that is arranged on the housing body and is configured to be electrically connected to the tray connector when the tray is coupled to the housing body.

10. The key container according to claim 1, further comprising:
a plate-shaped battery used as a power supply; and
a substrate including a circuit, the circuit being configured to actuate the drive mechanism with electric power from the plate-shaped battery,
wherein the plate-shaped battery and the substrate are held upright inside the housing.
